(19) United States
(12) Patent Application Publication
(10) Pub. No.: US 2020/0125851 A1
(43) Pub. Date: Apr. 23, 2020

(54) SOCIAL MEDIA PLATFORM AND MOBILE APPLICATION FOR CONNECTING NEARBY USERS

(71) Applicant: TAPE, INC., Santa Monica, CA (US)

(72) Inventor: Dario Dara Alizad, Santa Monica, CA (US)

(21) Appl. No.: 16/661,968

(22) Filed: Oct. 23, 2019

Related U.S. Application Data
(60) Provisional application No. 62/749,650, filed on Oct. 23, 2018.

(51) Int. Cl. G06K 9/00; G06Q 50/00; G06F 3/01; G06T 19/00; H04L 12/58; H04L 29/08; G06F 16/9535

(52) U.S. Cl. CPC G06K 9/00671; G06Q 50/01; G06F 3/011; G06F 16/9535; H04L 51/32; H04L 67/306; G06T 19/006

(57) ABSTRACT

An application for mobile devices that provides access to a social media platform. The application provides real time information to users of the platform regarding the identities and locations of other users on the platform that are proximate to a particular user. The information is then provided to the user so that connections can be made. The information may be provided in such a way that it is overlaid against a background environment that is generated by a camera integral with the user's mobile device to provide an augmented reality display.

### RELATED APPLICATION

This application claims the benefit of U.S. Provisional Application 62/749,650, filed on Oct. 23, 2018. The application referred to in this paragraph is incorporated herein as if set forth in its entirety.

### BACKGROUND OF THE DISCLOSURE

### Field of the Disclosure

The disclosure relates generally to social media platforms and mobile applications for accessing those platforms, and more particularly, social media platforms that allow users to connect with nearby users.

### Description of the Related Art

Social media websites provide platforms for interactions between users. Current social media platforms include, for example, Facebook, Twitter, LinkedIn, Snapchat, Tinder, and many others. Current social medial platforms offer interaction between users over a computer network, generally when the users are not in the same physical location. Thus, if a first user wants to invite a second user to interact, he/she typically browses the information that the second user has made public via the second user's profile and sends an invitation based on the interest generated by the second user's profile. Current social media platforms do not offer the opportunity to review a second user's information in a real-time augmented reality display when the second user is in the same physical location as the first user.

### BRIEF DESCRIPTION OF THE DRAWINGS

FIG. 1 shows a display screen with a graphical user interface on a mobile electronic device using the application in Heads-Up Mode according to an embodiment of the present disclosure.

FIG. 2 shows a display screen with a graphical user interface on a mobile electronic device using the application in Map View Mode according to an embodiment of the present disclosure.

FIG. 3 shows a display screen with a graphical user interface on a mobile electronic device using the application in List Mode according to an embodiment of the present disclosure.

FIG. 4 shows a display screen with a graphical user interface on a mobile electronic device using the application to view a user profile according to an embodiment of the present disclosure.

FIG. 5 shows a display screen with a graphical user interface on a mobile electronic device using the application to accept or decline a request according to an embodiment of the present disclosure.

FIG. 6 shows a display screen with a graphical user interface on a mobile electronic device using the application to manage a set of active or past chat sessions according to an embodiment of the present disclosure.

FIG. 7 shows a display screen with a graphical user interface on a mobile electronic device using the application to display previously saved profiles according to an embodiment of the present disclosure.

FIG. 8 shows a display screen with a graphical user interface on a mobile electronic device using the application to view a home screen according to an embodiment of the present disclosure.

### DETAILED DESCRIPTION OF THE DISCLOSURE

Certain aspects and advantages of the disclosure will become apparent from the following detailed description and the accompanying drawings which illustrate by way of example the features of the disclosure.

Relative terms used in the disclosure such as “inner”, “outer”, “upper”, “above”, “lower”, “beneath”, and “below”, and similar terms, may be used to describe a relationship of one graphic, object, or element to another. It is understood that these terms are intended to encompass different orientations and configurations of the devices, methods, and designs in addition to the orientations and configurations depicted in the figures.

Although the terms first, second, etc. may be used herein to describe various users, steps, elements, components, regions, layers and/or sections, these users, elements, components, regions, layers and/or sections should not be limited by these terms. These terms are only used to distinguish one user, step, element, component, region, layer or section from another. Thus, a first user, step, element, component, region, layer or section discussed below could be termed a second user, element, component, region, layer or section without departing from the teachings of the present disclosure.

Embodiments of the disclosure are described herein with reference to exemplary illustrations that, in some cases, are schematic illustrations of embodiments of the devices, methods, and designs of the present disclosure. As such, variations from the shapes of the illustrations such as, for example, customizations and optimizations are expected. Embodiments of the present disclosure should not be construed as limited to the particular shapes, sizes, designs, or layouts illustrated herein. Thus, the devices, methods, and designs illustrated in the figures are representative in nature and are not intended to unnecessarily limit the scope of the disclosure.

Embodiments of the disclosure include a social media platform accessible with mobile devices running a mobile application that allows a first user to connect with other users that are physically proximate to the first user. The application provides a home screen that allows the first user to connect with other users in several different ways.

Heads-Up Mode

The first user can open a feature that enables Heads-Up Mode navigation which utilizes, for example, the camera, geolocation, and gyroscope of the mobile device to identify nearby active users with an augmented reality (“AR”) presentation. That is, as the mobile device is moved around a room, for example, other active users are identified in real time in the mobile device field of view with an indicator. The indicators can be bubbles with some profile information appearing above another user's head, for example. The indicators may also be text and/or graphics floating close to another user, for example. Indicators may incorporate sounds and/or haptic feedback as well. Many different kinds of indicators are possible in Heads-Up Mode. In this way, real time information regarding other users that are proximate to the first user may be displayed in a field of view on a mobile device, with the information being overlaid against a background environment that is generated by a camera integral with the mobile device to provide the AR display.

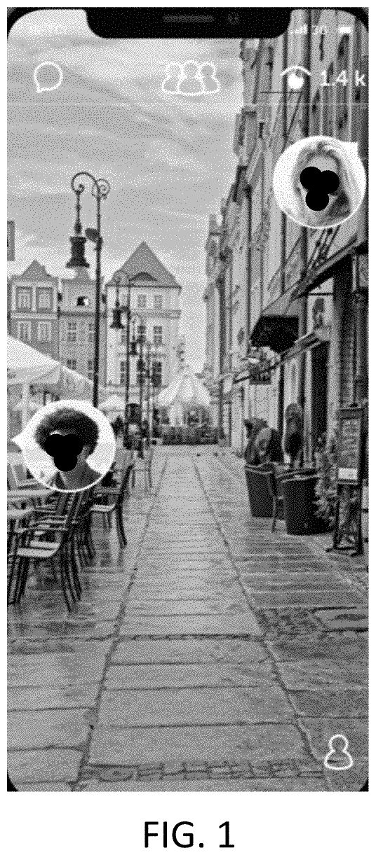

FIG. 1 shows a display screen with a graphical user interface on a mobile electronic device using the application in Heads-Up Mode according to an embodiment of the present disclosure.

Map Mode

The first user can open a feature that does not utilize the camera but does utilize geolocation and the gyroscope to present a directional map-style view that indicates proximate users including directional information related to the location of those users. For example, the map-style view may indicate that a particular user is a specified distance to the left of the first user. Other users in the map-style view may also be indicated by text, graphics, sounds, haptic feedback, or any combination thereof.

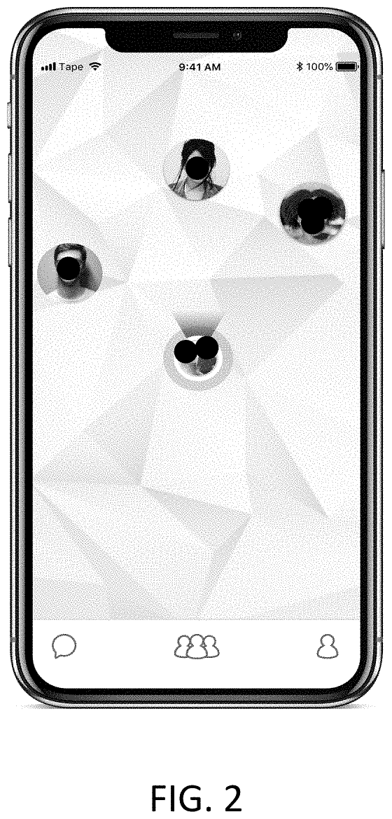

FIG. 2 shows a display screen with a graphical user interface on a mobile electronic device using the application in Map View Mode according to an embodiment of the present disclosure.

List Mode

In the List Mode, the first user can open up a feature that displays other proximate users in a list. In one exemplary embodiment, the List Mode screen organizes user information in rows with the user name and picture on the left of the row and other information related to the position of the listed user in the right portion of the row, for example, a compass-style arrow that points in the direction where the specific user is located relative to the first user. Other information can also be displayed in each row, for example, the distance that a particular user is away from the first user.

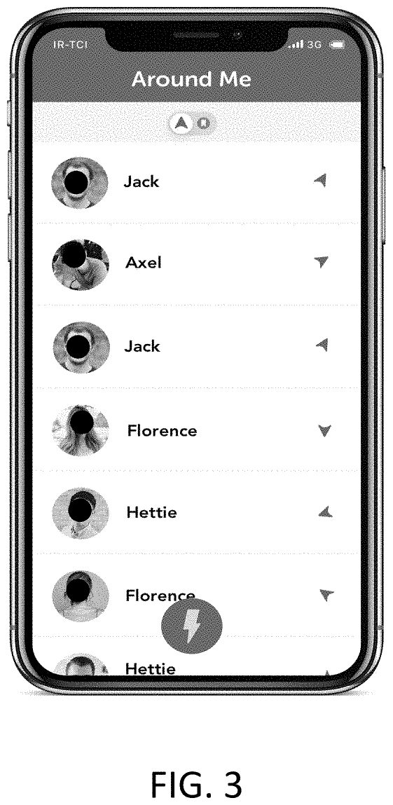

FIG. 3 shows a display screen with a graphical user interface on a mobile electronic device using the application in List Mode according to an embodiment of the present disclosure.

Each proximate user's information can be viewed by accessing that user's profile, which includes information related to the user and/or graphics, pictures, or text that the user chooses to display on his/her profile page. A user profile can be accessed, for example, by touching the display screen in an area close to the user's name, regardless of the mode which is being used. Other means of selecting a user profile are also possible.

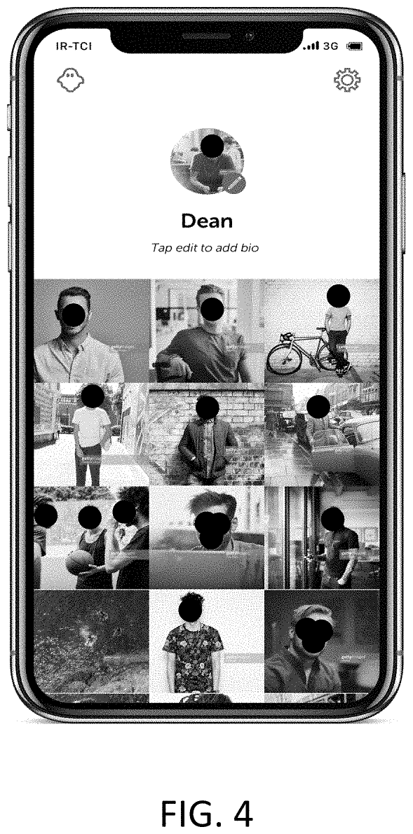

FIG. 4 shows a display screen with a graphical user interface on a mobile electronic device using the application to view a user profile according to an embodiment of the present disclosure.

Making a Connection

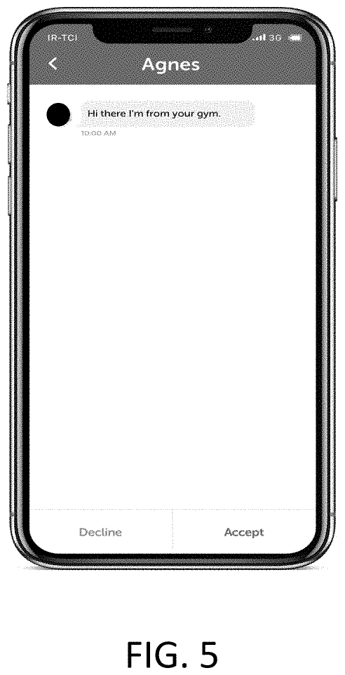

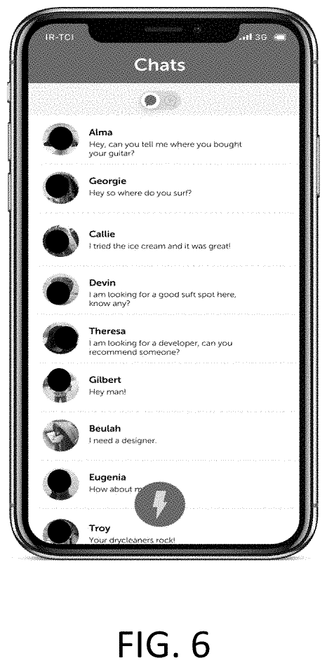

If the first user is interested in connecting with another proximate user, the first user can send a connect request immediately using a “Connect Now” option, in which case the user targeted for connection receives the request in real time. As shown in FIG. 5, in one embodiment, the target user can either accept or deny the request. If the target user accepts the connect request, the users become two-way connected in the social media sense and a chat session is initiated between the two users. If the target user ignores the request, then the requesting user and the target user are one-way connected (e.g., the requesting user becomes a follower of the target user). In one embodiment, a user can view all active and past chat sessions on a Chats screen, as shown in FIG. 6.

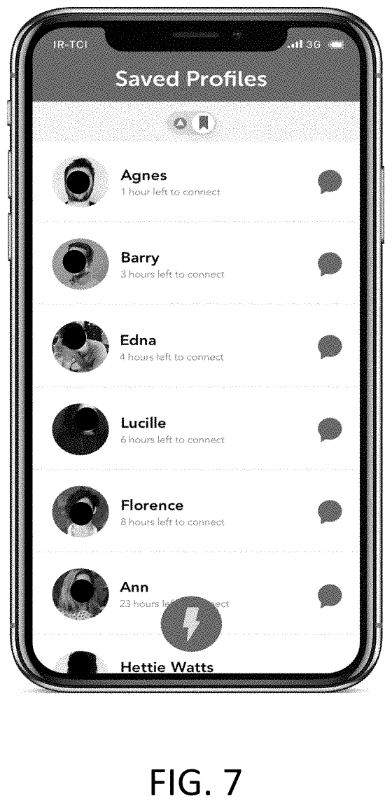

Instead of sending a connect request immediately, the first user can also choose a “Connect Later” option. This action places a reminder in the first user's chat window prompting the user to send a connect request at a later time. In one embodiment, these reminders can be anchored to the top of the chat session or a feed so that it always appears on the screen when the user's chat/feed is open. In another embodiment, the reminders can be displayed on a separate Saved Profile page, as shown in FIG. 7. Additionally, the reminders may be set to expire after a specified time period, for example, 24 hours.

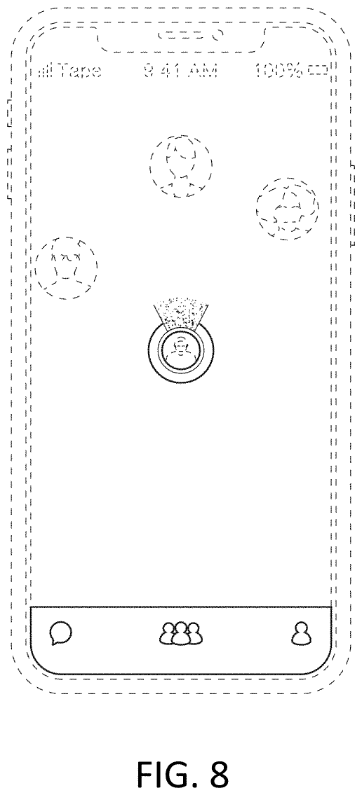

FIG. 8 shows a display screen with a graphical user interface on a mobile electronic device using the application to view a home screen according to an embodiment of the present disclosure.

As shown in FIG. 8, the home screen of the mobile application provides the users with at least three options. A “Messages” button (shown in the bottom left corner of the screen) opens the user's chat/feed. An “Around You” button (shown in the bottom middle of the screen) opens up the nearby user location feature, using the Heads-Up Mode, Map Mode, or List Mode presentation options. A “Views” button (shown in the bottom right corner of the screen) allows the user to track the number of views his/her profile has received over time, during a specific time period, or at a specific location, for example. The profile views are tracked anonymously.

User Feed and Feed Zones

In another embodiment of the application, a scrolling user feed is accessible by each user. The feed contains information such as the name of each user posting, a profile picture, the time of the post, and a post message (e.g., text, a picture/graphic, or a combination thereof).

The feed may be limited temporally such that only posts within a given time period, for example, the past 24 hours are displayed.

The feed may also be limited to a subset of users within a certain distance from the viewing user, for example, within 500 feet. In this way virtual barriers or feed zones can be created such that a user will only have access to a feed associated with a particular room/area when the user if physically present in that room/area, i.e., within the feed zone. For example, a user may be able to access a feed associated with a particular study hall when the student is within a predetermined distance of a GPS location associated with that study hall. The user may program his/her own geofences to define feed zones, in which case those spatio-specific feed parameters can be shared with other users, or users may access spatio-specific feeds which have been preprogrammed. Access to feeds may be open to users regardless of location, or access may be limited to users in the feed zone or by other criteria.

Although embodiments of the present disclosure have been described in detail with reference to certain preferred configurations thereof, other versions are possible. Any of the features of the devices, methods, and designs described herein can be used in combination with any of the other features described herein. The spirit and scope of the disclosure should not be limited to the versions described above.

I claim:

1. A method of connecting users on a social media platform, comprising:
receiving data associated with users on a social media platform, said data comprising information relating to the identities of said users and the locations of said users;
providing a first user with real time information regarding other users that are physically proximate to said first user;
receiving input from said first user comprising a connection request for a target user;
transmitting said connection request to said target user;
providing an option to said target user to accept the connection request, deny the connection request, or ignore the connection request;
if said connection request is accepted by said target user, opening a two-way communication between said first user and said target user.

2. The method of claim 1, wherein said real time information regarding other users that are proximate to said first user is displayed in a field of view on a mobile device, said information overlaid against a background environment that is generated by a camera integral with said mobile device to provide an augmented reality display.
